(19) United States
(12) Patent Application Publication
(10) Pub. No.: US 2004/0073800 A1
(43) Pub. Date: Apr. 15, 2004

(54) Adaptive intrusion detection system

(76) Inventors: Paragi Shah, Conshohocken, PA (US); Vikram Phatak, Lower Gwynedd, PA (US); Robert Scipioni, Collegeville, PA (US)

Correspondence Address: Schnader Harrison Segal & Lewis LLP, Suite 3600, 1600 Market Street, Philadelphia, PA, 19711, US

(21) Appl. No.: 10/443,568

(22) Filed: May 22, 2003

Related U.S. Application Data
(60) Provisional application No. 60/357,957, filed on May 22, 2002.

(51) Int. Cl. H04L 9/00

(52) U.S. Cl. 713/176

(57) ABSTRACT

An intrusion detection method wherein a vulnerability determination or vulnerability assessment of one or more computers or hosts is performed to determine whether and what vulnerabilities exist on the computers or hosts, accomplished by using existing vulnerability determination or vulnerability assessment information that can be continually updated. Attack signatures, which can also be continually updated, are identified and correlated with the specific vulnerabilities identified. One or more designated IP sessions associated with attempted vulnerability exploitation are then inhibited or disconnected.

This application is based, and claims priority to, provisional application having serial No. 60/357,957, a filing date of May 22, 2002, and entitled An Adaptive Intrusion Detection System for a Computer Network.

### BACKGROUND OF THE INVENTION

1. Field of the Invention

The present invention relates to an adaptive intrusion detection system for a computer system or network. More particularly, the present invention relates to an adaptive intrusion detection system for a computer network that is capable of recognizing both known and new types of computer attacks by learning from known types of attacks and past attacks against computer networks and automatically compensating for changes in the network that impact the vulnerability state and vulnerabilities of computers and hosts and the systems and services on the network.

2. Description of the Prior Art

Traditionally, securing sensitive systems and their information from being accessed by unwanted parties over a public system meant just that—controlling access. Unfortunately, the public nature of the Internet makes networks more easily vulnerable to attack by malevolent external entities, such as computer hackers, who create programs that launch computer attacks against networks, typically by attempting to circumvent or penetrate the network's firewall. Consequently, security is an issue of foremost concern for any organization utilizing a publicly accessible network, such as the Internet to communicate. More and more sophisticated methods have been created to address the weaknesses of the systems before them. Access control is not enough.

In response to the need for an added level of control over access to information there has been a focus on monitoring the actual content of the data, or payload, flowing into and out of systems. The purpose of this monitoring is to detect intruders. Intrusion detection is a method of monitoring all access to systems, with the hope of identifying access with a malicious intent to exploit vulnerabilities of those systems. These exploits can be used as a vehicle to, among other things, gain access to information, or to deny authorized users from using the system's resources. The intent of gathering this data by security personal is to either learn of vulnerabilities a system possesses (which can then be used to remediate the situation), or to identify the source of the intrusion in hopes to deny further access. The data gathered from intrusion detection systems can also be used in an attempt to penalize the offender.

Unfortunately, existing intrusion detection systems used, as a compliment to access control, has not sufficiently addressed the problems. Monitoring all access to systems consumes valuable time and resources. It also requires a relatively high level of technical prowess to determine when an event of note has taken place. Many (if not most) times the responsible party reviewing the data misinterprets it or is unable to respond in a timely fashion. Clearly the prior art of intrusion detection is a useful tool, but a limited one.

Controlling access to information is not reacting to events after they have occurred, but determining where systems and services are vulnerable before the access has taken place. Armed with this information a solution can then become active in defending those resources.

Network security hardware, software and/or firmware, such as firewalls and intrusion detectors and the like, are typically employed to monitor traffic across the computer network and to manage security. When an attack occurs, the event is generally logged and the network administrator may be alerted by the network security system, although generally after the damage to the network has occurred, if the network was vulnerable to the attack. In these conventional systems, the network administrator, sitting at a terminal, attempts to manually defend against attacks.

These conventional security systems have significant drawbacks: a)they can only recognize a type of attack that they have been preprogrammed to detect b)they can not adapt to attack types using past types of attacks as a guide, c) the number of known (much less unknown) attack types against networks, numbering in the thousands, is great, while the number of attack types that can be successful against a particular network are relatively small, usually less than one hundred and, without continuous significant manual adjustments to reflect the actual systems, services and vulnerabilities of a particular network, the security system cannot distinguish between attack types that can be successful against a particular network, due to the vulnerabilities of the particular network, from attack types that cannot succeed against a particular network because the vulnerabilities to those attack types do not exist in the particular network, thus making it nearly impossible for a network administrator to timely respond to an attack type that can succeed against a particular network, d) the security system cannot adjust to changes in the network without a network administrator's continuous review of a particular network's systems, services and related attack vulnerabilities, and subsequent continuous adjustment of the security system to reflect those changes. These systems have the significant disadvantage that if the security system does not properly identify an attack that, due to the particular network's vulnerabilities, can be successful, and, just as important, distinguish the attack from the multitude of attacks that will not be successful, then critical portions of the network can be penetrated or damaged before the administrator can recognize that a successful attack has occurred.

Accordingly, an intrusion detection system is needed that is capable of: a)adapting to new types of computer attacks and storing information on known attacks and logging and acting on relevant attacks against the network, b)automatically identifying the vulnerabilities that exist in a particular network's systems and services and updating such information when changes occur in the systems and services, c) automatically updating its databases of globally (all networks including systems and services available for networks) known systems and services vulnerabilities, and the associated attack types that attempt to exploit those vulnerabilities, d)correlating the actual vulnerabilities that exist in a particular network with the signature information identifying attack types that attempt to exploit those vulnerabilities, e) actively looks for only those attack types to which the particular network is vulnerable, known as relevant attack types and taking action when relevant attack types are identified, alerting network administrators, stopping the attacks or instructing the firewall to stop the attacks, or some combination of these, before the attacks can penetrate and damage portions of the computer network.

### SUMMARY OF THE INVENTION

The present invention can be embodied in intrusion detection software that can, among other ways, either be installed on a computer hardware device that contains security gateway software, such as a firewall, or it can be installed on a separate computer hardware device and operate as an independent detection sensor or integrated with security gateway software.

Advantageously, the software can operate directly on the security gateway. Most current devices are in-line, i.e. traffic passes through them either before or after the gateway, or operate as a tap. In-line devices generally operate in a redundant capacity providing many of the same restrictions on communications that the security gateway already performs, while ones that operate as a tap on the network wire usually do not inhibittraffic in the same fashion. Rather than dropping, i.e. not responding to further attempts, they break the session down, meaning that they communicate with the source and tell it to reset the session.

Embodiments of the invention include a method wherein the vulnerability state, including the specific vulnerabilities of one or more computers comprising a particular network's systems and services, is determined or a specific vulnerability assessment of one or more computers is performed to determine the vulnerability state of the particular network and its systems and services and what specific vulnerabilities exist on the computers. This is accomplished using vulnerability information that is automatically updated. Attack signatures, specific to globally known vulnerabilities are correlated with the vulnerabilities identified in the particular network and its systems and services.

### DESCRIPTION OF THE DRAWINGS

The invention is best understood from the following detailed description when read with the accompanying drawings.

FIG. 1 depicts the operation of an adaptive intrusion detection system according to an illustrative embodiment of the invention.

FIG. 2 depicts the operation of an adaptive intrusion detection system according to a further illustrative embodiment of the invention.

### DETAILED DESCRIPTION OF THE INVENTION

The present invention is directed to an intrusion detection system, which has the ability to adapt over time, and is preferably used in conjunction with, or integrated into, a network security system such as a firewall. One of ordinary skill in the art will appreciate that the present invention may be implemented as any of a number of well-known platforms, preferably in a client/server architecture, although not limited thereto.

The present invention can interact with the security system's firewall, and can provide a highly effective response that can either disconnect (or block) malicious communication traffic or connections, or instruct a firewall to do so, without disrupting legitimate traffic.

An Internet-based Web interface may also be used to allow access to content such as updated information databases, firewall policy configurations, and the intrusion detection logs.

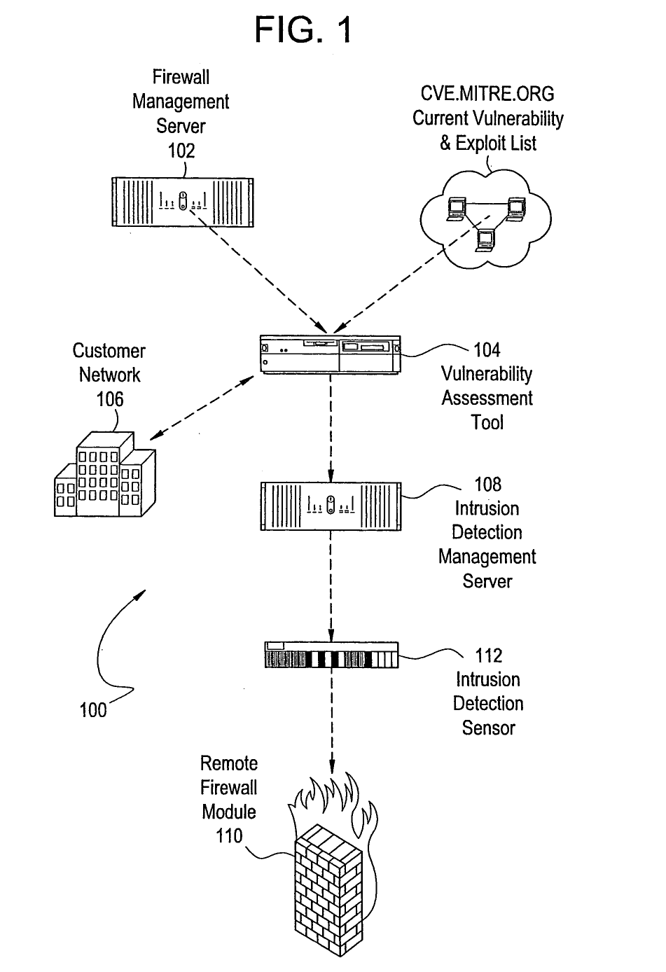

FIG. 1 depicts an illustrative embodiment of the operation of an adaptive intrusion detection system 100. This figure depicts the functionality of the present invention and shows the present invention as a separate computer. The present invention can also be located on the same device as the security gateway or integrated with the security gateway. As shown in FIG. 1, the firewall policy information is transferred from the firewall management server 102 into a vulnerability assessment or determination tool 104. A currently updated list of vulnerabilities is then also loaded into vulnerability assessment or determination tool 104. This list may be stored on firewall management server 102, on a separate hardware device or stored at a separate location.

Based upon the information contained in the firewall policy and the vulnerabilities list, if the vulnerability assessment tool is used, the vulnerability assessment tool 104 conducts an attack on the relevant equipment on computer network 106 that had been designated as potentially vulnerable to attack. The relevant equipment may be one or more computers or hosts. The vulnerabilities of this equipment and its resident systems and services are then determined and preferably loaded onto an intrusion detection management server 108. The intrusion detection management server 108 then preferably correlates these vulnerabilities with attack signatures. The intrusion detection management server 108 is then preferably instructed to only identify these attack signatures. The intrusion detection management server 108, preferably through an intrusion detection sensor 112, then instructs a firewall 110 to block the specific sessions that have been identified.

In this way, vulnerability assessment tool 104 has enabled intrusion detection management server 108 to properly identify exploits to which the equipment in computer network 106 is vulnerable, classifying them as “valid attacks.” All other known attacks are then characterized as “invalid attacks.” Because only a small percentage of traffic will be improperly identified as matching a known attack pattern, and, of those patterns identified, only a small percentage will match valid attacks, the present invention has the significant advantage that it can substantially eliminate false positive identifications of attacks.

Vulnerability, as used herein, means a flaw in a product that makes it infeasible—even when using the product properly—to prevent an attacker from usurping privileges on the user's system, regulating its operation, compromising data on it, or assuming ungranted trust. Vulnerability assessment means any method to determine what, and/or if any vulnerabilities exist on an application. A vulnerability assessment tool means any tool that can carry out a vulnerability assessment/determination, and is not limited, for example, to a scanning tool. Vulnerability assessments can be performed on applications which include systems and services residing on computers and hosts such as in a network. Vulnerability information means any information that relates to characterizing or identifying vulnerabilities, for example, procedures, rules.

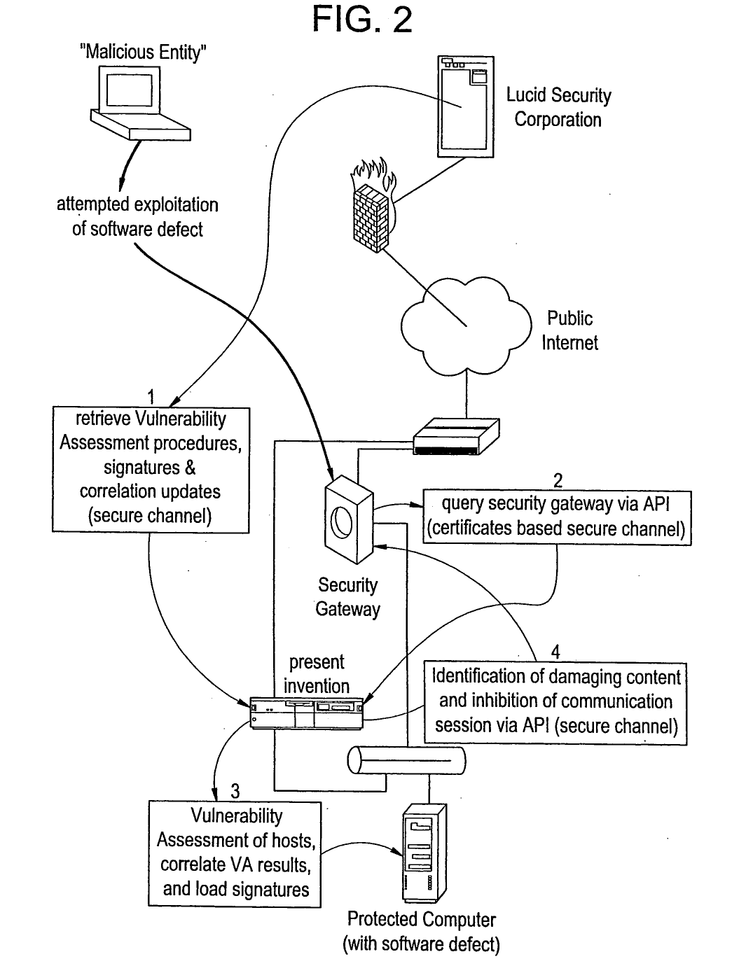

FIG. 2 depicts an intrusion detection system according to a further illustrative embodiment of the invention. This figure also depicts the functionality of the present invention and shows the present invention as a separate computer. The present invention can also be located on the same device as the security gateway or integrated with the security gateway. In step 1, vulnerability information, assessment procedures and rules are retrieved from a central computer. Periodically, such as once every twenty-four hours, the time of which can be determined by the operator, the intrusion detection system, through a secure communication session to a central computer, transfers files to its local operating system. These files contain Vulnerability information and Assessment (VA) procedures and rules (referred to as signatures) updated with globally known data, and data which directly relates, or correlates, these dissimilar sets of information. These files can be continuously updated for the most recent known vulnerability and attack information by an operator.

In step 2, a security gateway (firewall) is queried. The intrusion detection system, through utilization of an interface such as an application interface (API), securely queries a repository located within a security gateway, or a management station, for Internet Protocol (IP) addresses and services which are offered by computers or hosts, protected by the security gateway, to the public Internet.

The vulnerability of computers or hosts is determined or assessed in Step 3. Among other methods, a VA of these computer(s) is performed using the information acquired by the query of the gateway, and the VA information and procedures previously transferred, to determine which computers are vulnerable and what, if any, defects may exist in the systems and services which would allow the computer(s) being tested to be compromised by a malicious entity.

Once this list of defects is gathered, a correlation is performed to match the specific attack signature(s) with the specific vulnerabilities determined in the above steps. These attack signatures define specific attributes a communication session would need to posses to exploit the identified defect.

The intrusion detection system then loads these attack signatures into a pattern detection engine that has direct access to the communication streams between the protected computer and the Internet. The detection engine examines all communication sessions that pass through the security gateway. Armed with the attack signatures the detection engine can identify specific traffic that is destined for a computer with a specific software defect. In another embodiment, the intrusion detection system can instruct the security gateway to only forward, to the pattern detection engine, communication destined for a computer or host that was, in the prior step, determined to have vulnerabilities, thereby improving overall efficiency.

In step 4, damaging content is identified and communications are inhibited. When the intrusion detection system has determined that a specific communication session possesses damaging content, the intrusion detection system inhibits, drops or discontinues further communication with the offending source or, it utilizes a second API or interface to securely instruct the security gateway to inhibit, drop or discontinue further communication with the offending source. The length of time for discontinuing further communication with the offending source can be predetermined and set by an operator. This process then protects the computer from communication sessions which would be damaging to it and/or prevents unauthorized access to private information or resources.

In a further embodiment of the invention the information discovered in the vulnerability determination or VA is used to determine a computer or host Vulnerability State. In traditional systems this is not a current consideration and the system has to expend excessive processing time interrogating each set of data contained in every communication session to all protected computers or hosts and the rate of traffic passing through the firewall and/or system is degraded. This is changed though by considering for which destination the traffic was bound. After the firewall checks a packet for the proper source, destination and service, it can make another check before the firewall/gateway or the intrusion detection engine engages in the process-intensive operation of trying to compare its payload against signatures—the destination's vulnerability state. Determining the vulnerability state of computers or host, the software program knows ahead of time that the destination is not vulnerable to a connection so the final in-depth signature based tests can be bypassed, and therefore, the communication traffic rate would is more efficient. By having the detection engine of the intrusion detection system or the firewall/gateway only examine communications that need to have a signature analysis performed, the software's performance can be improved.

The invention further includes a computer readable medium and a system comprising one or more computers to carry out the methods described herein.

While the invention has been described by illustrative embodiments, additional advantages and modifications will occur to those skilled in the art. Therefore, the invention in its broader aspects is not limited to specific details shown and described herein. Modifications, for example, to the computer hardware, order of method steps and configuration of components, may be made without departing from the spirit and scope of the invention. Accordingly, it is intended that the invention not be limited to the specific illustrative embodiments, but be interpreted within the full spirit and scope of the appended claims and their equivalents.

1. An intrusion detection method comprising:
retrieving vulnerability information;
retrieving attack signatures;
performing a vulnerability assessment of one or more of the following, computers, hosts or combination thereof to determine what vulnerabilities exist on the aforementioned; and
correlating the attack signatures with the determined existing vulnerabilities to identify vulnerability exploit attempts.

2. The intrusion detection method of claim 1 further comprising:
distinguishing between traffic to the one or more computers and/or host having vulnerabilities and those not having vulnerabilities; and
only performing a vulnerability assessment on the one or more computers and/or hosts having vulnerabilities.

3. The intrusion detection method of claim 1 further comprising:
only including attack signatures that are specific to the identified vulnerabilities in the correlation step.

4. The intrusion detection method of claim 1 wherein the existence of vulnerabilities on the computer(s) is determined by:
querying a security gateway for IP addresses and services of the computers; and
using the vulnerability information and the IP addresses and services.

5. The intrusion detection method of claim 1 further comprising:
inhibiting or disconnecting one or more designated IP sessions associated with attempted vulnerability exploitation.

6. The intrusion detection method of claim 1 further comprising:
updating the vulnerability information; and
repeating the steps of claim 1.

7. The intrusion detection method of claim 1 further comprising:
determining the computer's vulnerability state, and if the computer is not vulnerable, bypassing the signature correlation step.

8. An intrusion detection system comprising:
a vulnerability determination tool to identify defects on one or more computers, hosts, or combination thereof
a correlation engine and database to correlate the defects with attack signatures to identify specific attack signatures that relate to the specific vulnerabilities identified;
an intrusion detection sensor to facilitate identifying and inhibiting or dropping IP sessions or communication traffic associated with the attempted exploitation of the specific vulnerabilities identified.

9. The intrusion detection system of claim 8 further comprising a firewall, wherein the intrusion detection sensor instructs the firewall to inhibit or drop IP sessions or communication traffic associated with the attempted exploitation of the specific vulnerabilities identified.

10. The intrusion detection system of claim 9 further comprising an application programming interface to pull vulnerability information into a vulnerability determination tool; and
wherein the application programming interface and firewall are integrated into a single component.

10. The intrusion detection system of claim 8 further comprising:
an application programming interface to pull vulnerability information into a vulnerability determination tool.

11. The intrusion detection system of claim 8 wherein a security gateway or firewall are integrated into a single component and or on a single device or computer.

12. The intrusion detection system of claim 1 further comprising an Internet-based Web interface.

13. The intrusion detection system of claim 1 further comprising a means for updating the vulnerability determination assessment tool.

14. A computer readable medium to carry out the method of claim 1.

15. A system comprising one or more computers to carry out the method of claim 1.

16. An intrusion detection method comprising:
retrieving network and system configuration information;
retrieving vulnerability information and attack signature rules;
analyzing potential vulnerabilities only for systems and services present in the network;
determining the presence of vulnerabilities or performing a vulnerability assessment of one or more computers or hosts to determine if the computers or hosts are vulnerable and what specific vulnerabilities exist on the computers;
retrieving vulnerability assessment information;
correlating the attack signatures with the specific vulnerabilities identified;
only examining communication traffic bound for vulnerable computers or hosts and/or only comparing communication traffic to the attack signatures that relate to the specific vulnerabilities of the computers, hosts or systems and services identified by the intrusion detection system; and
dropping or inhibiting traffic or instructing the security gateway to drop or inhibit traffic identified by the intrusion detection engine of the system or the firewall as matching the attack signatures that relate to the specific vulnerabilities identified by the intrusion detection system.
